(19) United States
(12) Patent Application Publication
(10) Pub. No.: US 2023/0010228 A1
(43) Pub. Date: Jan. 12, 2023

(54) LUMINAIRE

(71) Applicant: ANTARES ILUMINACIÓN, S.A.U., Valencia (ES)

(72) Inventor: Federico MARTINEZ WEBER, Valencia (ES)

(21) Appl. No.: 17/783,488

(22) PCT Filed: Apr. 2, 2020
(86) PCT No.: PCT/ES2020/070219

§ 371 Date: Jun. 8, 2022

(51) Int. Cl. G02B 19/00; F21S 8/06; F21V 5/04

(52) U.S. Cl. CPC G02B 19/0047; F21S 8/061; F21V 5/048

(57) ABSTRACT

The present invention relates to an optical device that enables the projection of the light to be controlled such that it comes out parallel to a non-active multi-cell shielding device, wherein said shielding device is not illuminated by the light beam, the user perceiving the light with all its intensity, without loss of intensity due to the reflection of said shielding device, wherein furthermore, due to the low profile thereof, the optical device enables same to be integrated into a luminaire with a reduced height dimension, which is also object of the present invention.

### OBJECT OF THE INVENTION

The present invention relates to an optical device that enables the projection of the light to be controlled such that it comes out parallel to a non-active multi-cell shielding device, wherein said shielding device is not illuminated by the light beam, the user perceiving the light with all its intensity, without loss of intensity due to the reflection of said shielding device.

Furthermore, due to the low profile thereof, the optical device enables same to be integrated into a luminaire with a reduced height dimension, which is also object of the present invention.

### BACKGROUND OF THE INVENTION

Optical devices are known in the prior art which have a shielding device that reflects the light emitted by a light source, such that the intensity of said light that reaches the user is dimmed, in addition to being confined to a specific shielding or cut-off angle due to said reflection made by the shielding device.

These optical devices are normally integrated into high-profile luminaires, which reduces the possibilities of integration in certain environments where the limitations associated with the available space prevent it from being placed.

For this reason, the light source must be placed very far from the light output area of the lighting device, making the necessary optical assembly very complex, resulting in a high cost of said lighting device.

Furthermore, luminaires are known which comprise multiple arrangements of optical bulbs with fixed or adjustable installation. In the first case, a specific area is illuminated by the arrangement of a specific screen near the light bulb. This is the case, for example, with floor lamps or with many other types of lamps attached as wall sconces or suspended from the ceiling. In the case of lamps with adjustable bulbs, devices are known wherein the screen or the light bulb assembly can be adjusted such that the light beam generated by the lamp is sent to the area to be illuminated. These types of lamps comprise different reflector structures that can be oriented and others.

However, they all have the drawback that they comprise complex mechanisms for orienting the light or making the light reach an area with a specific intensity.

The luminaire of the present invention comprising said optical device solves all the previously described drawbacks.

### DESCRIPTION OF THE INVENTION

The present invention relates to an optical device that enables the projection of the light to be controlled such that it comes out parallel to a non-active multi-cell shielding device, wherein said shielding device is not illuminated by the light beam, the user perceiving the light with all its intensity, without loss of intensity due to the reflection of said shielding device.

The optical device comprises
at least one light source intended to radiate a light beam in an essentially vertical downward direction;
a lens that in turn comprises:
   a first refractive surface through which the light beam is refracted; and
   a second refractive surface through which the light beam refracts;
wherein the first refractive surface is arranged between the at least one light source and the second refractive surface;
wherein the first refractive surface and the second refractive surface are essentially parabolic; and
wherein the first refractive surface and the second refractive surface are arranged such that the vertices of said parabolic surfaces are the furthermost points between each of them and the at least one light source in the essentially vertical downward direction; and
a shielding device defining therein an interior space;
wherein the second refractive surface is confined in the interior space defined by the shielding device;

The optical device thus configured enables the projection of the light to come out parallel to the shielding device, such that said shielding device is non-active, since the light beam does not strike said shielding device and therefore is not reflected, the user perceiving the light with all its intensity, without loss of intensity due to the reflection of said shielding device.

Furthermore, the shielding device, without being active, avoids dazzling the user when said user is not located under the optical device.

Optionally, the lens further comprises a first total internal reflection (TIR) surface that surrounds the at least one light source up to the first refractive surface, such that all of the light rays of the light beam leaving the at least one light source are directed to the first refractive surface, either by direct incidence or by reflection thereof on the first total internal reflection surface.

Optionally, the vertex of the first refractive surface is arranged at the same height as an upper end of the second refractive surface in the essentially vertical downward direction.

Optionally, the projection of the first refractive surface in the essentially vertical downward direction is contained in the second refractive surface.

In this way, all of the light rays of the light beam that are refracted by the first refractive surface reach the second refractive surface, without loss of intensity of the at least one light source occurring as it passes through the lens.

Optionally, the shielding device has an essentially truncated pyramid shape.

Preferably, the optical device comprises a light source. Also preferably, the optical device comprises two adjacently arranged light sources.

The invention also relates to a luminaire comprising at least one optical device of those described previously.

Optionally, the luminaire further comprises a housing wherein the at least one optical device and holding means for holding said luminaire are arranged. Preferably, these holding means comprise cables configured to support the luminaire on a ceiling.

Preferably, the luminaire comprises a plurality of adjacently arranged optical devices.

### DESCRIPTION OF THE DRAWINGS

As a complement to the description provided herein, and for the purpose of helping to make the features of the invention more readily understandable, in accordance with a preferred practical exemplary embodiment thereof, said description is accompanied by a set of drawings constituting an integral part of the same, which by way of illustration and not limitation, represent the following:

FIG. 1 shows a cross-sectional view of the optical device of the present invention wherein the distribution of the light rays emitted by the at least one light source as it passes through the lens has been represented.

FIG. 2 shows an elevation view of the luminaire comprising a set of optical devices.

FIG. 3 shows a bottom view of FIG. 2.

FIG. 4 shows a detail A of FIG. 2.

FIG. 5 shows a cross-sectional view BB of FIG. 4.

FIG. 6 shows a view of the luminaire of the invention wherein three optical devices and the distribution of the light rays emitted by the at least one light source as it passes through the lens of each optical device have been represented.

FIG. 7 shows a perspective view of FIG. 2.

FIG. 8 shows a detail C of FIG. 7.

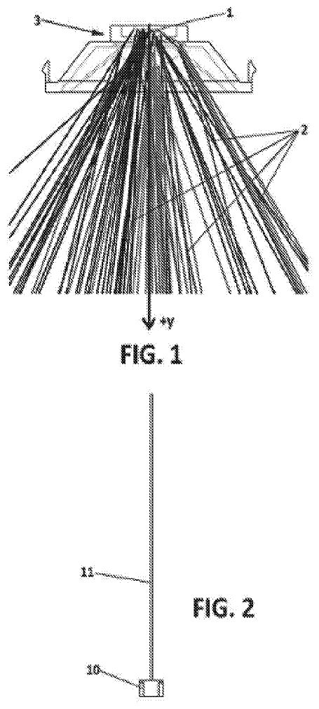

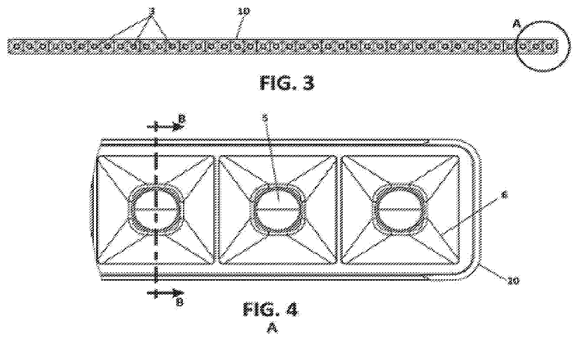

### PREFERRED EMBODIMENT OF THE INVENTION

The optical device of the present invention is described below in detail.

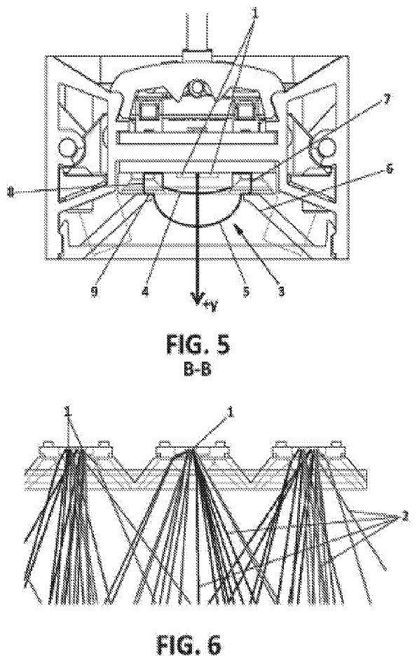

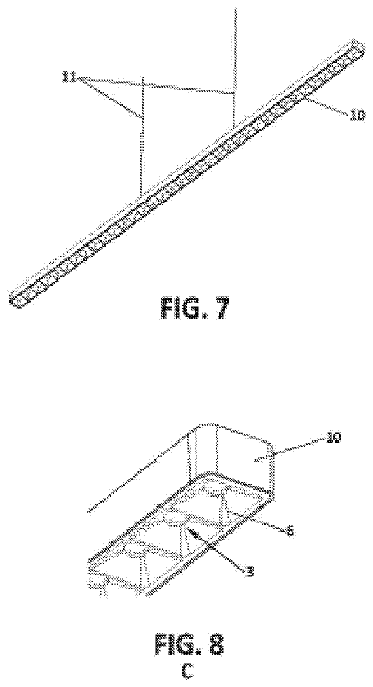

The optical device, as shown in FIG. 5, comprises
at least one light source (1) intended to radiate a light beam (2) in an essentially vertical downward direction (+Y);
a lens (3) that in turn comprises:
   a first refractive surface (4) through which the light beam (2) is refracted; and
   a second refractive surface (5) through which the light beam (2) refracts;
wherein the first refractive surface (4) is arranged between the at least one light source (1) and the second refractive surface (5);
wherein the first refractive surface (4) and the second refractive surface (5) are essentially parabolic; and
wherein the first refractive surface (4) and the second refractive surface (5) are arranged such that the vertices of said parabolic surfaces are the furthermost points between each of them and the at least one light source (1) in the essentially vertical downward direction (+Y); and
a shielding device (6), preferably having truncated pyramid shape, which defines therein an interior space;
wherein the second refractive surface (5) is confined in the interior space defined by the shielding device (6).

The optical device thus configured enables the projection of the light to come out parallel to the shielding device (6), such that said shielding device (6) is non-active, as seen in FIG. 1.

The lens (3) further comprises a first total internal reflection surface (7) that surrounds the at least one light source (1) up to the first refractive surface (4), such that all of the light rays of the light beam (2) leaving the at least one light source (1) are directed to the first refractive surface (4), either by direct incidence or by reflection thereof on the first total internal reflection surface (7). Preferably, the first total internal reflection surface (7) is cylindrical. More preferably, the first total internal reflection surface (7) comprises a diameter that coincides with a diameter of the first refractive surface (4), this diameter of the first refractive surface (4) being the largest diameter of said essentially parabolic first refractive surface (4).

Preferably, the vertex of the first refractive surface (4) is arranged at the same height as an upper end of the second refractive surface (5) in the essentially vertical downward direction (+Y).

Preferably, the lens (3) further comprises a second total internal reflection surface (8, 9) that surrounds the at least one light source (1) and the first total internal reflection surface (7) up to the second refractive surface (5), such that all of the light rays of the light beam (2) that pass through the first refractive surface (4) are directed to the second refractive surface (5) either by direct incidence or by reflection thereof on the second total internal reflection surface (8, 9).

Preferably, the second total internal reflection surface (8, 9) is cylindrical, with a cylindrical section (8) and a flat section (9) connecting the cylindrical section (8) and the second refractive surface (5). More preferably, the cylindrical section (8) of the second total internal reflection surface (8, 9) comprises a diameter that is larger than a diameter of the second refractive surface (5), this diameter of the second refractive surface (5) being the largest diameter of said essentially parabolic second refractive surface (5).

Preferably, the projection of the first refractive surface (4) in the essentially vertical downward direction (+Y) is contained in the second refractive surface (5).

Preferably, the optical device may comprise a light source (1). Also preferably, the optical device may comprise two adjacently arranged light sources (1).

The invention also relates to a luminaire comprising at least one optical device of those described previously.

Preferably, the luminaire further comprises a housing (10) wherein the at least one optical device and holding means (11) for holding said luminaire are arranged, these holding means (11) being cables configured to support the luminaire on a ceiling (not shown).

In this exemplary embodiment, the luminaire comprises a plurality of adjacently arranged optical devices, preferably 54, held by 4 cables.

Preferably, the luminaire comprises a first set of optical devices comprising a light source (1) and a second set of optical devices comprising two adjacently arranged light sources (1), wherein the first set of optical devices and the second set of optical devices are arranged alternating in the luminaire.

1. An optical device comprising:
at least one light source (1) intended to radiate a light beam (2) in an essentially vertical downward direction (+Y);
a lens (3) that in turn comprises:
a first refractive surface (4) through which the light beam (2) is refracted; and
a second refractive surface (5) through which the light beam (2) refracts;
wherein the first refractive surface (4) is arranged between the at least one light source (1) and the second refractive surface (5); and
a shielding device (6) defining therein an interior space;
characterised in that the first refractive surface (4) and the second refractive surface (5) are essentially parabolic; and
wherein the first refractive surface (4) and the second refractive surface (5) are arranged such that the vertices of said parabolic surfaces are the furthermost points between each of them and the at least one light source (1) in the essentially vertical downward direction (+Y); and
wherein the second refractive surface (5) is confined in the interior space defined by the shielding device (6).

2. The optical device according to claim 1, characterised in that the lens (3) further comprises a first total internal reflection surface (7) that surrounds the at least one light source (1) up to the first refractive surface (4).

3. The optical device according to claim 2, characterised in that the first total internal reflection surface (7) is cylindrical.

4. The optical device according to claim 3, characterised in that the first total internal reflection surface (7) comprises a diameter that coincides with a diameter of the first refractive surface (4), this diameter of the first refractive surface (4) being the largest diameter of said essentially parabolic first refractive surface (4).

5. The optical device according to any of claims 2 to 4, characterised in that the lens (3) further comprises a second total internal reflection surface (8, 9) that surrounds the at least one light source (1) and the first total internal reflection surface (7) up to the second refractive surface (5).

6. The optical device according to claim 5, characterised in that the second total internal reflection surface (8, 9) is cylindrical, with a cylindrical section (8) and a flat section (9) connecting the cylindrical section (8) and the second refractive surface (5).

7. The optical device according to claim 6, characterised in that the cylindrical section (8) of the second total internal reflection surface (8, 9) comprises a diameter that is larger than a diameter of the second refractive surface (5), this diameter of the second refractive surface (5) being the largest diameter of said essentially parabolic second refractive surface (5).

8. The optical device according to any of the preceding claims, characterised in that the vertex of the first refractive surface (4) is arranged at the same height as an upper end of the second refractive surface (5) in the essentially vertical downward direction (+Y).

9. The optical device according to any of the preceding claims, characterised in that the projection of the first refractive surface (4) in the essentially vertical downward direction (+Y) is contained in the second refractive surface (5).

10. The optical device according to any of the preceding claims, characterised in that it comprises a light source (1).

11. The optical device according to any of the preceding claims, characterised in that it comprises two adjacently arranged light sources (1).

12. The optical device according to any of the preceding claims, characterised in that the shielding device (6) has a truncated pyramid shape.

13. A luminaire comprising at least one optical device according to any of the preceding claims.

14. The luminaire according to claim 13, characterised in that it further comprises a housing (10) wherein the at least one optical device and holding means (11) for holding said luminaire are arranged.

15. The luminaire according to claim 14, characterised in that the holding means (11) comprise cables configured to support the luminaire on a ceiling.

16. The luminaire according to claim 15, characterised in that it comprises a plurality of adjacently arranged optical devices, preferably 54, held by 4 cables.

17. The luminaire according to any of claims 13 to 16, characterised in that it comprises a first set of optical devices comprising a light source (1) and a second set of optical devices comprising two adjacently arranged light sources (1), wherein the first set of optical devices and the second set of optical devices are arranged alternating in the luminaire.
